(19) United States
(12) Patent Application Publication
(10) Pub. No.: US 2025/0371035 A1
(43) Pub. Date: Dec. 4, 2025

(54) METHOD FOR GENERATING CUSTOMIZED CONTENTS SCREENING TABLE FOR EACH THEATER AND DEVICE THEREFOR

(71) Applicant: CJ OLIVENETWORKS CO., LTD., Seoul (KR)

(72) Inventors: Hyun Woo Jin, Seoul (KR); Kyong Mook Lim, Seoul (KR); Yi An Seo, Seoul (KR); Jongsoo Sohn, Seoul (KR)

(21) Appl. No.: 19/303,887

(22) Filed: Aug. 19, 2025

Related U.S. Application Data
(63) Continuation of application No. PCT/KR2024/095375, filed on Feb. 19, 2024.

(30) Foreign Application Priority Data
Feb. 20, 2023 (KR) 10-2023-0022318

(51) Int. Cl. G06F 16/28

(52) U.S. Cl. CPC G06F 16/283

(57) ABSTRACT

The present invention relates to a method of generating a contents screening table customized for each theater and a system for the same. More specifically, the present invention relates to a method and system for deriving, when a contents screening table generation server acquires data on commercial districts around each theater, data on contents, and data on social networks from an analysis resource data providing server, prediction result values (e.g., number of audiences, main age group, etc.) by learning the acquired data using a prediction modeling algorithm, and generating a contents screening table customized for each theater on the basis of the prediction result values.

### CROSS-REFERENCE TO RELATED APPLICATION(S)

This application is a Continuation of International Patent Application No. PCT/KR2024/095375, filed on Feb. 19, 2024, which claims priority under 35 U.S.C. § 119 to Korean Patent Application No. 10-2023-0022318, filed on Feb. 20, 2023, in the Korean Intellectual Property Office, the disclosure of which are incorporated by reference herein in its entireties.

### TECHNICAL FIELD

The present invention relates to a method of generating a contents screening table customized for each theater and a system for the same. More specifically, the present invention relates to a method and system for deriving, when a contents screening table generation server acquires data on commercial districts around each theater, data on contents, and data on social networks from an analysis resource data providing server, prediction result values (e.g., number of audiences, main age group, etc.) by learning the acquired data using a prediction modeling algorithm, and generating a contents screening table customized for each theater on the basis of the prediction result values.

### BACKGROUND ART

Although various services that users may enjoy in indoor convenience facilities have been developed due to recent spread of corona virus, convenience facilities where users are likely to be crowded in an enclosed indoor space, such as the facilities that provide contents related to movies, concerts, musicals, and the like, have encountered a period of recession due to government regulations such as social distancing.

In order to overcome the period of recession, movie contents providers have tried to attract many audiences by organizing movie contents customized to the audiences considering viewing data of the audiences purchased in the past, movie preferences of the audiences, and the like, and screening the movie contents that suit the tastes of the audiences.

Although a process of collecting and analyzing audience data (e.g., age, gender, preferences) and the like is essential to organize the movie contents that suit the tastes of the audiences, as the process is performed manually by a movie organizing team relying on experience and intuition, a lot of time and efforts are required, and there is an inconvenience of recruiting manpower to organize movies.

Although the movie organizing team devote time and efforts to organize movies that suit the tastes of the audiences, as the characteristics of audiences visiting each theater and the surrounding commercial districts are diverse, reactions of the audiences to the movie organization have also brought a different result for each theater, and particularly, there is even a case in which the reservation rate of a theater is extraordinarily low compared to those of existing movie organizations based on a movie release date.

The present invention has been conceived based on the problems, and invented to provide additional technical elements that cannot be easily devised by those skilled in the art, in addition to solving the technical problems described above.

### DISCLOSURE

### Technical Problem

Therefore, the present invention has been made in view of the above problems, and it is an object of the present invention to provide a method of generating a contents screening table customized for each theater, and a system for the same, which can generate the contents screening table by acquiring data that can be the characteristics of each theater located at each branch, and analyzing the acquired data through an artificial intelligence model, without the need of manually organizing movies by a movie organizing team.

Another object of the present invention is to provide a system capable of extracting characteristics of each theater from various aspects by analyzing data that can be the characteristics of each theater, such as data on the surrounding commercial districts of each theater, data on the number of times of mentioning keywords related to the contents (e.g., actors, director, production company, etc.) through the Social Network Service (SNS), and the like, in addition to analyzing superficial viewing data such as viewing data and movie preferences of audiences, in order to generate a contents screening table customized for each theater.

The technical problems of the present invention are not limited to the technical problems mentioned above, and unmentioned other technical problems can be clearly understood by those skilled in the art from the following description.

### Technical Solution

To accomplish the above object, according to one aspect of the present invention, there is provided a method of generating a contents screening table customized for each theater by a contents screening table generation server, the method comprising the steps of: (a) acquiring analysis resource data of each theater from at least one analysis resource data providing server; (b) deriving a prediction result value on the basis of the acquired analysis resource data by a prediction modeling algorithm; and (c) generating a contents screening table on the basis of the prediction result value.

According to an embodiment, the at least one analysis resource data providing server may include at least one among a theater server, a social network server, a commercial district statistics server, and an Over-The-Top (OTT) server.

According to an embodiment, the analysis resource data may be data that can be acquired from the theater server, i.e., data including at least one among a list of currently screened contents, a list of contents to be screened, a running time of contents, a genre of contents, a main viewing age group of contents, and a main viewing gender of contents.

According to an embodiment, the analysis resource data may be data that can be acquired from a social network, i.e., data including at least one among the number of times of mentioning contents-related keywords by audiences who use the social network and the number of recommendations of an article or a message including the contents-related keywords, wherein the contents-related keywords are keywords including at least one among keywords of actors starring in the contents and keywords of a production company or a director who has produced the contents.

According to an embodiment, the analysis resource data may be data that can be acquired from a commercial district statistics server, i.e., data including at least one among a residential population, a workplace population, and a floating population around each theater, an income level compared to the residential population, and an income level compared to the workplace population.

According to an embodiment, the analysis resource data may be data that can be acquired from an OTT server, i.e., data including at least one among a list of contents currently provided by the OTT server, contents preferences, a main viewing age group of contents, a main viewing gender of contents, and contents of which the number of queries has increased rapidly within a predetermined period of time.

According to an embodiment, step (b) may include the steps of: (b-1) extracting feature data of each theater by analyzing the analysis resource data, by the prediction modeling algorithm; and (b-2) generating a prediction result value by learning the extracted feature data, by the prediction modeling algorithm.

According to an embodiment, the feature data of each theater may be data generated by analyzing the analysis resource data by the contents screening table generation server, i.e., data including at least one among a residential purpose of audiences living around each theater, a difference between a work income and a residential income, contents preferences, and the number of times of mentioning contents-related keywords.

According to an embodiment, the prediction result value may be a value including at least one among the number of audiences, a main age group of the audiences, a main gender group of the audiences in each theater according to a time zone, day of week, or date acquired by learning the feature data.

According to an embodiment, step (b) may further include, after step (b-2), the step of (b-3) correcting the prediction result value derived by the prediction modeling algorithm, using an ensemble algorithm.

According to an embodiment, the method of generating a contents screening table customized for each theater may further comprise, after step (c), the step of (d) updating the prediction model on the basis of an attendance rate of each theater or a result of reaction of the audience according to the attendance rate of each theater.

According to another aspect of the present invention, there is provided a contents screening table generation system for generating a contents screening table customized for each theater, the system comprising: an analysis resource data providing server for providing analysis resource data of each theater to a contents screening table generation server, and including at least one among a theater server, a social network server, a commercial district statistics server, and an Over-The-Top (OTT) server; and the contents screening table generation server for acquiring analysis resource data of each theater from at least one analysis resource data providing server, deriving a prediction result value on the basis of the acquired analysis resource data by a prediction modeling algorithm, and generating a contents screening table on the basis of the prediction result value.

According to another aspect of the present invention, there is provided a contents screening table generation server comprising a central processing unit for executing a set of instructions for executing a method of generating a content screening table customized for each theater, and a memory for storing the set of instructions, wherein the method of generating a content screening table customized for each theater includes the steps of: (a) acquiring analysis resource data of each theater from at least one analysis resource data providing server; (b) deriving a prediction result value on the basis of the acquired analysis resource data by a prediction modeling algorithm; and (c) generating a contents screening table on the basis of the prediction result value.

### Advantageous Effects

According to the present invention as described above, as a contents screening table customized for each theater is generated by analyzing data that can be the characteristics of each theater through an artificial intelligence model, there is an effect of providing conveniences of work to employees who manually organize movies, and as contents customized to the tastes of audiences can be organized on the basis of the characteristics of each theater, there is also an effect, from the perspective of the audiences, in that the audiences may be provided with desired contents at a time and a theater they prefer.

In addition, when a contents screening table customized for each theater is generated, as characteristics of each theater are extracted through various aspects of data, such as data on social networks, data on surrounding commercial districts, and the like, and the extracted characteristics of each theater are analyzed, there is an effect of generating a more accurate and optimized contents screening table customized for each theater.

The effects of the present invention are not limited to the effects mentioned above, and unmentioned other effects will be clearly understood by those skilled in the art from the following description.

### DESCRIPTION OF DRAWINGS

FIG. 1 is a view for conceptual understanding of a system for generating a contents screening table according to a first embodiment of the present invention.

FIG. 2 is a view showing the overall configuration of a system according to a first embodiment of the present invention as a simple schematic diagram.

FIG. 3a is a view showing analysis resource data provided by a theater server and an OTT server according to a first embodiment of the present invention.

FIG. 3b is a view showing analysis resource data provided by a social network server according to a first embodiment of the present invention.

FIG. 3c is a view showing analysis resource data provided by a commercial district statistics server 204 according to a first embodiment of the present invention.

FIG. 4 is a view showing a process of extracting feature data, as a simple table and a schematic diagram, from analysis resource data acquired by a contents screening table generation server according to a first embodiment of the present invention.

FIG. 5 is a view showing a process of generating a contents screening table customized for each theater through a prediction modeling algorithm and delivering the customized contents screening table to each theater server as a simple schematic diagram by a generation server according to a first embodiment of the present invention.

FIG. 6 is a flowchart illustrating a method of generating a contents screening table customized for each theater according to a first embodiment of the present invention.

FIG. 7 is a view specifically showing the step of generating a prediction model by analyzing analysis resource data by a server according to a first embodiment of the present invention.

FIG. 8 is a flowchart illustrating a method of generating a contents screening table customized for each theater according to a second embodiment of the present invention.

### MODE FOR INVENTION

Hereinafter, preferred embodiments of the present invention will be described in detail with reference to the accompanying drawings. Advantages and features of the present invention and methods for achieving them will become clear with reference to the embodiments described below in detail in conjunction with the accompanying drawings. However, the present invention is not limited to the embodiments disclosed below and may be implemented in various different forms, and these embodiments are provided only to make the disclosure of the present invention complete and to fully inform those skilled in the art of the scope of the present invention, and the present invention is only defined by the scope of the claims. Like reference numbers refer to like elements throughout the specification.

Unless otherwise defined, all terms (including technical and scientific terms) used in this specification can be used as a meaning that can be commonly understood by those skilled in the art. In addition, terms defined in commonly used dictionaries are not interpreted ideally or excessively unless explicitly and specifically defined. Terms used in this specification are for describing the embodiments and are not intended to limit the present invention. In this specification, singular forms also include plural forms unless specifically stated otherwise in a phrase.

Terms such as “first” and “second” are used to distinguish one component from another component, and the scope of rights should not be limited by these terms. For example, a first component may be named a second component, and similarly, a second component may also be named a first component.

“Comprises” and/or “comprising” used in this specification means that a mentioned component, step, operation, and/or element does not preclude the presence or addition of one or more other components, steps, operations, and/or elements.

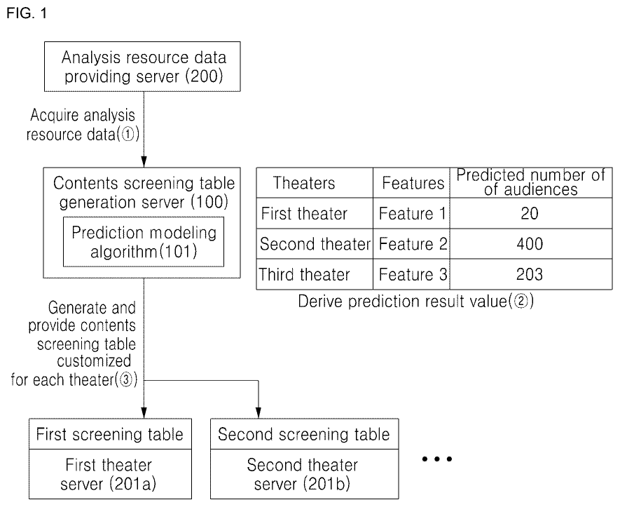

FIG. 1 is a view for conceptual understanding of a system for generating a contents screening table 10 according to a first embodiment of the present invention.

Referring to FIG. 1, the system for generating a contents screening table of the present invention (hereinafter, abbreviated as a system 10) relates to a system in which when a contents screening table generation server 100 \textcircled{1} acquires analysis resource data information (e.g., information on the commercial district statistics of each theater, information on contents, and information on social networks) from an analysis resource data providing server 200, the system \textcircled{2} derives prediction result values (e.g., number of audiences, main age group, etc.) by learning the acquired analysis resource data information by a prediction result value algorithm 101, \textcircled{3} generates a contents screening table customized for each theater on the basis of the prediction result values, and provides the generated customized contents screening table to each theater server (201a, 201b).

For reference, the ‘contents’ referred to herein may include advertisements provided to the audiences before the movie is screened, as well as the movie itself provided to the audiences in a theater, and may also include media contents provided for the purposes of education, literature, news, entertainment, and the like.

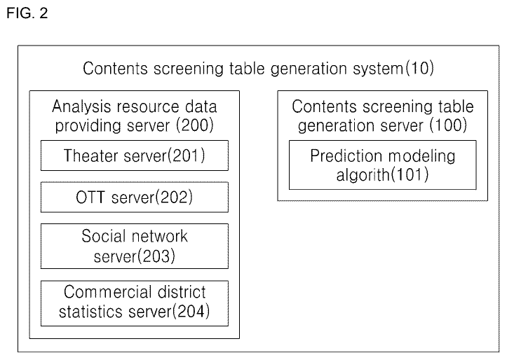

FIG. 2 is a view showing the overall configuration of a system 10 according to a first embodiment of the present invention as a simple schematic diagram.

Referring to FIG. 2, the system 10 according to a first embodiment of the present invention may include a contents screening table generation server 100 and an analysis resource data providing server 200.

The contents screening table generation server (hereinafter, abbreviated as a generation server 100) is a server that generates and provides a contents screening table customized for each theater by utilizing the characteristics of each theater (e.g., surrounding commercial districts, reservation status, etc.).

The generation server 100 may include a prediction modeling algorithm 101 that learns the characteristics of each theater and derives various prediction result values on the basis of the learned data to generate a customized contents screening table according to the characteristics of each theater or various events (incidents, accidents).

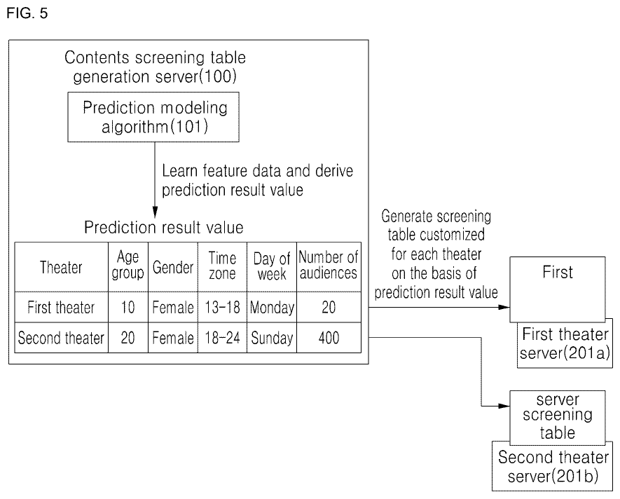

The process of deriving the prediction result values by the prediction modeling algorithm 101 will be described in detail in FIG. 5.

As the term implies, the analysis resource data providing server 200 is a server that provides data resources so that the generation server 100 may analyze the characteristics of each theater.

The analysis resource data providing server 200 may include a theater server 201, an OTT server 202, a social network server 203, and a commercial district statistics server 204, which provide analysis resource data so that the generation server 100 may analyze the characteristics of each theater in various aspects.

The theater server 201 is a server that controls a theater that screens contents to audiences, and stores information on the contents currently screened (or released), contents to be screened, and all contents screened in the past in a database included in the server.

Here, information on the contents may include information on the contents, such as the title, genre, contents, actors, and director of the contents.

In addition, the theater server 201 may store information on the audiences of the contents, such as the number of audiences corresponding to the contents, the age and gender of the audiences, the age or gender of main audience, and the like, in addition to the information on the contents, in the database included in the server.

The theater server 201 stores information on the contents actually screened in the theater, information on the contents to be screened, or information on the audiences actually visiting the theater, and analysis resource data that can be acquired from the theater server 201 may be analysis resource data relatively realistic compared to other analysis resource data.

The OTT server 202 is a service server that provides various types of contents (e.g., broadcast programs, movies, education, etc.) through the Internet or applications.

As the OTT server 202 may store information on the contents and audiences of the contents in the database included in the server like the theater server 201, and provide contents online anytime anywhere unlike the theater server 201 that provides contents offline, analysis resource data that can be acquired from the OTT server 202 may include a relatively large amount of data related to the contents in comparison with other analysis resource data, and may include data that can be analyzed in various aspects, such as contents currently preferred by the audiences, contents desired to view according to age/gender, and the like.

The social network server 203 is a server that generates and strengthens social relationship through free communication, information sharing, and expansion of social network among the audiences.

The social network server 203 provides social contents (e.g., messages, postings, etc.) generated in the process of free communication and information sharing among the audiences to the generation server 100 as analysis resource data, so that the generation server 100 may analyze contents that attract attention currently, events (incidents and accidents) currently occurring in the society, and the like on the basis of the social content.

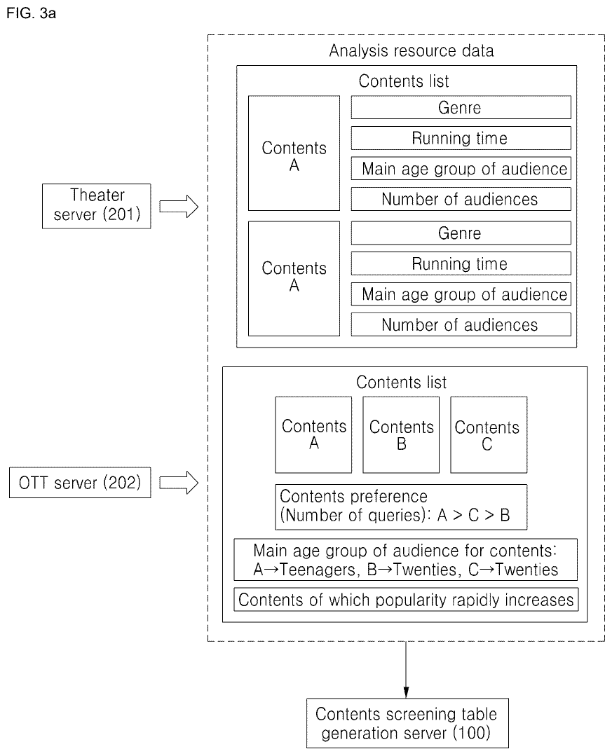

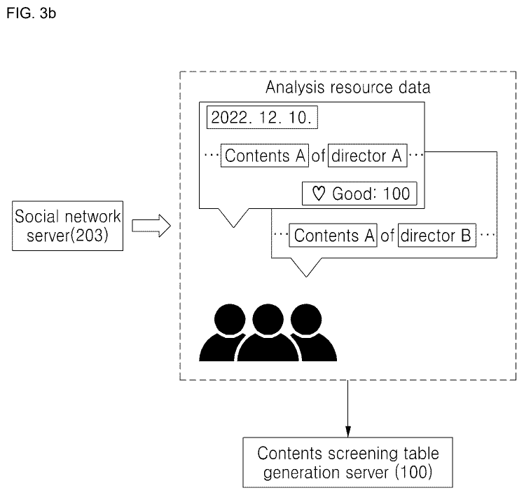

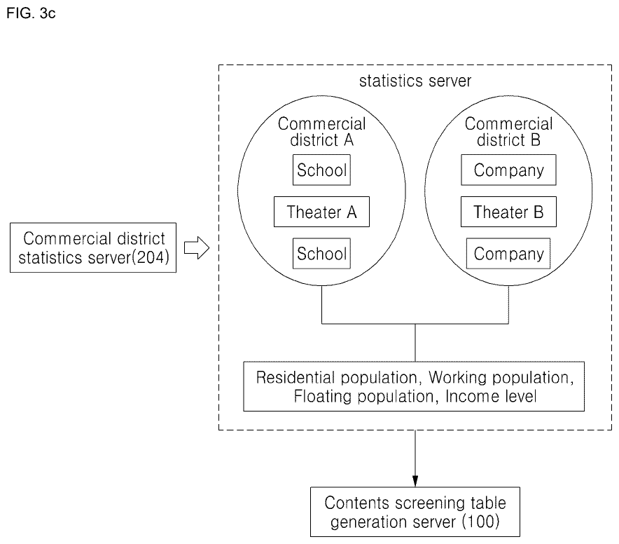

The process of utilizing the social contents of the social network server 203 as analysis resource data of the generation server 100 will be described in detail in FIG. 3b.

The commercial district statistics server 204 is a server that provides information on the commercial districts around each theater digitized in numeric values.

The commercial district statistics server 204 may be a demographic server operated by the government or a server operated by a professional commercial district analysis company that closely investigates and analyzes surrounding commercial districts.

The analysis resource data that can be acquired from the commercial district statistics server 204 allows the generation server 100 to analyze commercial factors (residential type, income status, and the like of surrounding population) unique to each theater, in addition to the analysis related to the contents, so that a more optimized contents screening table customized for each theater may be generated.

The overall configuration of the system 10 according to a first embodiment of the present invention has been described above.

Next, before describing a method of generating a contents screening table customized for each theater according to a first embodiment of the present invention, terms frequently used in the present invention will be described briefly.

### [Analysis Resource Data]

FIG. 3a is a view showing analysis resource data provided by the theater server 201 and the OTT server 202 of the present invention.

Referring to FIG. 3a, the theater server 201 and the OTT server 202 provide the generation server 100 with analysis resource data including information on contents or information on audiences who have viewed the contents.

For example, the theater server 201 may provide the generation server 100 with analysis resource data including information on a contents list listing contents A and contents B, a genre matching each of contents A and B, a running time, a main age and gender group of audiences, and information on the total number of audiences.

The OTT server 202 may provide the generation server 100 with analysis resource data including information on a contents list listing contents A, contents B, or contents C, preference of contents (e.g., contents A>contents C>contents B), a main age group viewing the contents, or contents of which the number of queries has increased rapidly within a predetermined period of time.

FIG. 3b is a view showing analysis resource data provided by the social network server 203 of the present invention.

As described above, the social network server 203 is a server that provides the generation server 100 with social contents (e.g., messages, postings, etc.) generated in the process of free communication and information sharing among the audiences as analysis resource data.

Since these social contents contain the thoughts and feelings of the audiences to some extent as they are generated through free communication and information sharing among the audiences, they may be used to grasp the interest that the audiences currently have (e.g., the contents that the audiences are paying attention to) while collecting and analyzing a large number of social contents.

Accordingly, the generation server 100 of the present invention is provided with social contents generated in the process of free communication and information sharing of the audiences from the social network server 203 as analysis resource data, and grasps contents that the audiences are interested in by analyzing ‘contents-related keywords’ included in the social contents.

The ‘contents-related keywords’ referred to herein may include keywords, as shown in FIG. 3b, such as keywords of actors starring in the contents, keywords of the production company or the director who has produced the contents, keywords of the date releasing the contents or the date uploading social contents close to the screening date, or keywords of incidents or accidents related to the main theme of the contents.

For reference, when the generation server 100 receives the social contents, which are the analysis resource data, from the social network server 203, it may analyze the number of likes or recommendations of the social contents, as well as the ‘contents-related keywords’ included in the social contents, and grasp contents that the audiences are interested in.

FIG. 3c is a view showing analysis resource data provided by the commercial district statistics server 204 of the present invention.

The commercial district around a theater is an important factor that can determine the reservation rate of the theater, i.e., overall sales of the theater. In other words, when contents that do not match the commercial district around a theater are screened, a relatively low reservation rate may be recorded. On the other hand, when contents that match the commercial district around the theater are screened, the reservation rate may be improved, and in addition, the audiences may also be provided with contents that match their residential type.

For example, when it is assumed that there is a plurality of schools in commercial district A around theater A and there is a plurality of companies in commercial district B around theater B, since it is highly probable that the residential type in commercial district A is for actual residence of the audiences, and thus the probability of visiting the theater and viewing contents is higher than in commercial district B due to the tendency of the audiences to use welfare facilities near their residences, the generation server 100 may organize more contents than in theater B in commercial district B, and since it is highly probable that audiences of all ages live therein as educational facilities such as schools are populated in commercial district A, a contents screening table customized only for theater A, which has a relatively large selection of contents that can be viewed by audiences of all ages, may be generated.

On the other hand, since it is highly probable that the residential type in commercial district B is for commuting to work rather than actually living in the area, and thus the probability of visiting the theater and viewing contents is relatively lower than in commercial district A, and it is highly probable that relatively high age groups are distributed in the area compared to commercial district A, the generation server 100 may organize less contents than in theater A included in commercial district A, and generate a screening table customized only for theater B, which has a relatively large selection of contents that can be viewed by audiences of relatively high age groups.

In this way, the commercial district statistics server 204 may provide the generation server 100 with analysis resource data including at least one among a residential population, a workplace population, and a floating population around each theater, an income level compared to the residential population, and an income level compared to the workplace population so that the generation server 100 may analyze the surrounding commercial districts unique to each theater and generate a screening table customized for each theater as described above.

### [Feature Data]

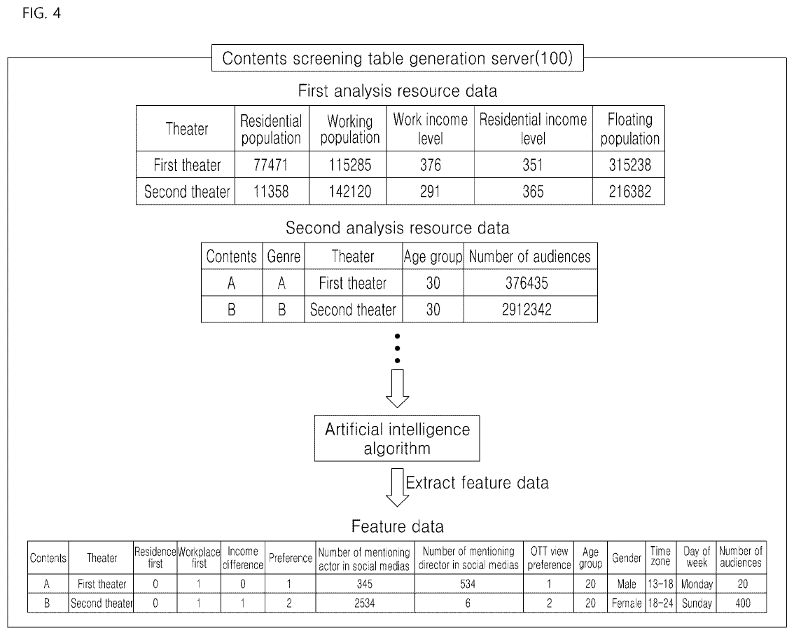

FIG. 4 is a view showing a process of extracting feature data, as a simple table and a schematic diagram, from analysis resource data acquired by a contents screening table generation server 100 according to a first embodiment of the present invention.

When the analysis resource data is acquired from the analysis resource data providing server 200, the generation server 100 may analyze and use the acquired data as is to generate a screening table customized for each theater. However, when the generation server 100 analyzes a large amount of analysis resource data as is provided by a plurality of analysis resource data providing servers 200, a long time is required to analyze the analysis resource data, and accurate and precise result values may be difficult to derive, and thus the generation server 100 may extract feature data that may be the characteristic of each theater from the acquired analysis resource data through an artificial intelligence algorithm that extracts feature data on the basis of learned data, and generate a screening table customized for each theater on the basis of the extracted feature data.

For reference, although the prediction modeling algorithm 101 mentioned above may function as an artificial intelligence algorithm that extracts feature data on the basis of learned data, an artificial intelligence algorithm performing only a function of extracting feature data of each theater may be separately implemented.

The feature data referred to herein may refer to data on the features of contents currently screened or scheduled to be screened at a theater, features of commercial districts around each theater, features of audiences visiting each theater, features of keywords included in the social contents, and the like, which are extracted by analyzing the acquired analysis resource data. In other words, the feature data are data including at least one among the residential purpose of audiences living around each theater, the difference between a work income and a residential income, contents preferences, and the number of times of mentioning contents-related keywords.

For example, when it is assumed that the generation server 100 acquires first analysis resource data related to a commercial district, such as a residential population, a workplace population, a work income level, and the like, from the commercial district statistics server 204, and acquires second analysis resource data related to contents, such as a contents list, genre, total number of audiences, and the like, from the first and second theater servers 201a and 201b, the generation server 100 may extract feature data on whether the commercial district around each of the first and second theaters is a residential type for actual residence or a residential type for commuting to work, and whether there is a difference between a work income level and a residential income level, feature data on the preference of contents ranked by the total number of audiences, feature data on the number of (or the number of times of mentioning) the keywords included in the social contents, and feature data on the preference of viewing OTT ranked by the number of online viewings, on the basis of the acquired first and second analysis resource data.

### [Prediction Modeling Algorithm (101)]

FIG. 5 is a view showing a process of generating a contents screening table customized for each theater through the prediction modeling algorithm 101 and delivering the customized contents screening table to each theater server 201 as a simple schematic diagram by the generation server 100 according to a first embodiment of the present invention.

When the analysis resource data is acquired and the feature data is extracted for each theater on the basis of the acquired analysis resource data, the generation server 110 should predict the type and number of audiences who will visit each theater on a specific date or at a specific time zone on the basis of the feature data to generate a contents screening table customized for each theater, and the generation server 110 may include a prediction modeling algorithm 101 for deriving prediction result values on the basis of the feature data of each theater.

Referring to FIG. 5, the prediction modeling algorithm 101 learns the feature data extracted from the current analysis resource data, forms a prediction model based on feature data learned currently, feature data learned in the past, or data input from a system manager in the past, and derives prediction result values such as the number of audiences predicted for each theater and the age/gender of the predicted audiences by analyzing the formed prediction model.

Here, the prediction result values may refer to values predicting the gender/age group and the number of audiences mainly visiting the theater on a specific date or at a specific time zone. For example, the prediction modeling algorithm 101 may learn and analyze feature data on the first theater to derive a prediction result value indicating that about 20 teenage female audiences will visit the first theater between 13:00 and 18:00 on Monday.

In addition, the prediction result value may be a value predicting the gender/age group of audiences mainly visiting the theater, an expected number of audiences, and the like on the basis of specific contents or a specific event (e.g., incident, accident, anniversary, etc.), as well as on the basis of a specific date or a specific time zone.

When the prediction modeling algorithm 101 derives prediction result values in this way, the generation server 100 generates a screening table customized for each theater based on the prediction result values and provides the screening table to each theater server 201a and 201b.

The terms frequently used in the present invention are described above briefly.

Next, a method of generating a content screening table customized for each theater according to first and second embodiments of the present invention will be described.

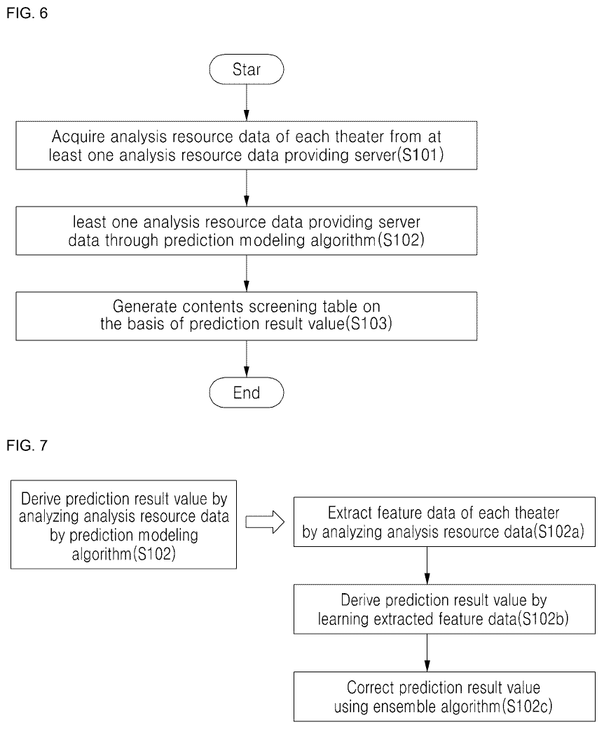

FIG. 6 is a flowchart illustrating a method of generating a contents screening table customized for each theater according to a first embodiment of the present invention.

A method of generating a contents screening table customized for each theater according to a first embodiment of the present invention first begins with a step of acquiring analysis resource data of each theater from at least one analysis resource data providing server 200 by the generation server 100 (S101). Here, the analysis resource data providing server 200 may include at least one among a theater server 201, an OTT server 202, a social network server 203, and a commercial district statistics server 204.

Then, the generation server 100 derives prediction result values by analyzing the analysis resource data through the prediction modeling algorithm 101 (S102). Here, the prediction modeling algorithm may refer to an algorithm that analyzes characteristics of each theater and derives prediction result values such as a predicted number of audiences for each theater, the age/gender of the predicted audiences, and the like.

FIG. 7 is a view specifically showing the step of deriving prediction result values by analyzing analysis resource data using the prediction modeling algorithm according to a first embodiment of the present invention (S102).

Referring to FIG. 7, step S102 includes the steps of analyzing the analysis resource data (S102a), deriving prediction result values by learning the extracted feature data (S102b), and correcting the prediction result values using an ensemble algorithm (S102c).

Step S102a is a step of extracting feature data that may be the characteristics of each theater from the analysis resource data acquired by the generation server 100. Here, the feature data may refer to data on the features of contents currently screened or scheduled to be screened at a theater, features of commercial districts around each theater, features of audiences visiting each theater, features of keywords included in the social contents, and the like, and at this point, the prediction modeling algorithm 101 may be used as a means for acquiring the feature data from the analysis resource data, or a separate artificial intelligence algorithm that performs only the function of extracting feature data of each theater may be used.

Step S102b is a step of predicting the type and number of audiences who will visit each theater on a specific date or at a specific time zone on the basis of the feature data, and deriving prediction result values thereof, by the prediction modeling algorithm 101 of the generation server 100. Here, the prediction result values may refer to predicted values of the gender/age group and number of audiences mainly visiting the theater on the basis of a specific date, a specific time zone, specific contents, or a specific event.

Step S102c is a step of changing and correcting the prediction result values, by the generation server 100, using an ensemble algorithm to improve accuracy of the prediction result values when the prediction modeling algorithm 101 derives the prediction result values. Here, the ensemble algorithm may refer to an algorithm using a method of determining final prediction result values by voting on the prediction result values acquired by a plurality of prediction modeling algorithms 101, or a method of performing learning in a way of improving accuracy of a subsequent prediction result value while assigning a weight to a next prediction modeling algorithm 101 to correctly predict data incorrectly predicted by a previous prediction modeling algorithm 101 when a plurality of prediction modeling algorithms 101 sequentially performs learning.

When the prediction modeling algorithm 101 of the generation server 100 derives prediction result values in this way, the generation server 100 generates a screening table customized for each theater on the basis of the prediction model result values (S103) and provides the customized screening table to each theater server 201.

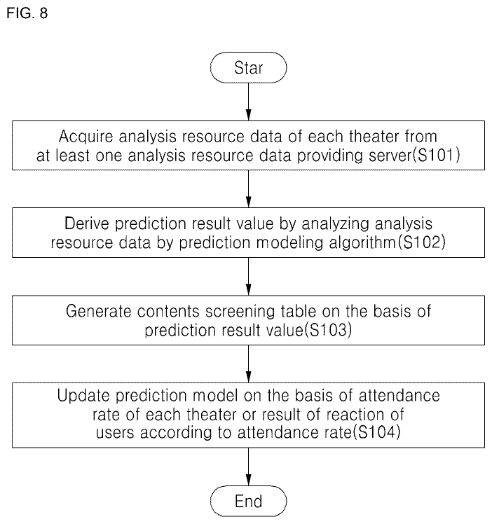

FIG. 8 is a flowchart illustrating a method of generating a contents screening table customized for each theater according to a second embodiment of the present invention.

*105 Although each theater server 201 provides contents to the audience on the basis of the contents screening table customized for each theater after step S103, the actual reaction of the audience (e.g., attendance rate, reservation rate) may be different, in other words, the prediction result values derived by the prediction modeling algorithm 101 may be different from actual result values, and thus these different result values should be learned and analyzed to derive more accurate prediction result values in the process of deriving subsequent prediction result values.

Accordingly, a method of generating a contents screening table customized for each theater according to a second embodiment of the present invention may include a step of updating the prediction model on the basis of the attendance rate of each theater or ‘a result of reaction of the audience according to the attendance rate’ (S104) after step S103.

The ‘result of reaction of the audience according to the attendance rate’ referred to herein may refer to the rating, number of recommendations, and the like given to the contents by the audiences after viewing the contents, and may refer to details of social contents uploaded by the audiences through the social network server 100 after viewing the contents, reviews uploaded by the audiences onto the theater server 201 after viewing the contents, or the like.

The present invention is not limited to the specific embodiments and applications described above, and various modifications can be made by those skilled in the art without departing from the gist of the present invention claimed in the claims, and these modified embodiments should not be understood separately from the technical spirit or perspective of the present invention.
10: Contents screening table generation system
100: Contents screening table generation server
200: Analysis resource data providing server
201: Theater server 202: OTT server 203: Social network server
204: Commercial district statistics server

1. A method of generating a contents screening table customized for each theater by a contents screening table generation server, the method comprising the steps of:
(a) acquiring analysis resource data of each theater from at least one analysis resource data providing server;
(b) deriving a prediction result value on the basis of the acquired analysis resource data by a prediction modeling algorithm; and
(c) generating a contents screening table on the basis of the prediction result value.

2. The method according to claim 1, wherein the at least one analysis resource data providing server includes at least one among a theater server, a social network server, a commercial district statistics server, and an Over-The-Top (OTT) server.

3. The method according to claim 1, wherein the analysis resource data is data that can be acquired from the theater server, i.e., data including at least one among a list of currently screened contents, a list of contents to be screened, a running time of contents, a genre of contents, a main viewing age group of contents, and a main viewing gender of contents.

4. The method according to claim 1, wherein the analysis resource data is data that can be acquired from a social network, i.e., data including at least one among the number of times of mentioning contents-related keywords by audiences who use the social network and the number of recommendations of an article or a message including the contents-related keywords, wherein the contents-related keywords are keywords including at least one among keywords of actors starring in the contents and keywords of a production company or a director who has produced the contents.

5. The method according to claim 1, wherein the analysis resource data is data that can be acquired from a commercial district statistics server, i.e., data including at least one among a residential population, a workplace population, and a floating population around each theater, an income level compared to the residential population, and an income level compared to the workplace population.

6. The method according to claim 1, wherein the analysis resource data is data that can be acquired from an OTT server, i.e., data including at least one among a list of contents currently provided by the OTT server, contents preferences, a main viewing age group of contents, a main viewing gender of contents, and contents of which the number of queries has increased rapidly within a predetermined period of time.

7. The method according to claim 1, wherein step (b) includes the steps of:
(b-1) extracting feature data of each theater by analyzing the analysis resource data, by the prediction modeling algorithm; and
(b-2) generating a prediction result value by learning the extracted feature data, by the prediction modeling algorithm.

8. The method according to claim 7, wherein the feature data of each theater is data generated by analyzing the analysis resource data by the contents screening table generation server, i.e., data including at least one among a residential purpose of audiences living around each theater, a difference between a work income and a residential income, contents preferences, and the number of times of mentioning contents-related keywords.

9. The method according to claim 7, wherein the prediction result value is a value including at least one among the number of audiences, a main age group of the audiences, a main gender group of the audiences in each theater according to a time zone, day of week, or date acquired by learning the feature data.

10. The method according to claim 7, wherein step (b) further includes, after step (b-2), the step of (b-3) correcting the prediction result value derived by the prediction modeling algorithm, using an ensemble algorithm.

11. The method according to claim 1, further comprising, after step (c), the step of (d) updating the prediction model on the basis of an attendance rate of each theater or a result of reaction of the audience according to the attendance rate of each theater.

12. A contents screening table generation system for generating a contents screening table customized for each theater, the system comprising:
an analysis resource data providing server for providing analysis resource data of each theater to a contents screening table generation server, and including at least one among a theater server, a social network server, a commercial district statistics server, and an Over-The-Top (OTT) server; and
the contents screening table generation server for acquiring analysis resource data of each theater from at least one analysis resource data providing server, deriving a prediction result value on the basis of the acquired analysis resource data by a prediction modeling algorithm, and generating a contents screening table on the basis of the prediction result value.

13. A contents screening table generation server comprising a central processing unit for executing a set of instructions for executing a method of generating a content screening table customized for each theater, and a memory for storing the set of instructions, wherein
the method of generating a content screening table customized for each theater includes the steps of:
(a) acquiring analysis resource data of each theater from at least one analysis resource data providing server;
(b) deriving a prediction result value on the basis of the acquired analysis resource data by a prediction modeling algorithm; and
(c) generating a contents screening table on the basis of the prediction result value.
